(19) United States
(12) Patent Application Publication
(10) Pub. No.: US 2011/0173941 A1
(43) Pub. Date: Jul. 21, 2011

(54) Power Transmission for a Lawn Mower and a Lawn Mower Provided with Such a Transmission

(76) Inventor: Leif Persson, Livermore, CA (US)

(21) Appl. No.: 12/301,849

(22) PCT Filed: May 25, 2007
(86) PCT No.: PCT/SE2007/000509

§ 371 Date: Nov. 21, 2008

Related U.S. Application Data
(60) Provisional application No. 60/803,348, filed on May 26, 2006.

(51) Int. Cl. A01D 43/00; F16H 7/02

(52) U.S. Cl. 56/17.1; 474/148; 56/320.1

(57) ABSTRACT

The present invention concerns a power transmission for a rotary type of walk-behind lawn mower. The transmission comprises a first transmission part (7A) arranged to be mounted in a lawn mower housing (1) and comprising a transmission pulley (6) , which in turn is arranged to be connected to an engine pulley (4) of a lawn mower via a drive belt (5) . A second part (7B) of the transmission is arranged to be connected to a wheel axle (9) of the lawn mower, wherein the first transmission part (7A) is connected to the second transmission part (7B) via an articulated joint (11) such that the second transmission part (7B) and the wheel axle (9) are arranged to be pivotally mounted on said lawn mower housing (1) . Thereby pivoting will adjust the height of said lawn mower housing (1) in relation to a ground plane. The invention also concerns a walk-behind lawn mower comprising such a transmission.

### TECHNICAL FIELD

The present invention concerns walk-behind rotary lawn mowers of dimensions typically less than 700 mm diameter and most commonly 480 to 530 mm diameter and equipped with a powered transmission that drives either the front or the rear wheels, and a transmission for such a lawn mower.

### BACKGROUND OF THE INVENTION

The typical rotary lawnmower has a variable cutting height varying from 20 mm to as much as 100 mm.

FIG. 1 shows a typical height adjustment mechanism in a lawn mower. The axle 101 that drives the wheels 102 is typically located at a fixed position on the mower deck. The drive axle 101 from the transmission 103 typically goes through the pivoting point 104 for the typical height adjustment pivoting system. To transmit the power from the transmission to the wheels the most common solution is to utilize a small gear 105 on the axle 101 that drives a gear in the wheel—for example on cogs on the inside parameter of the wheel.

Another similar solution utilizing a chain drive system at the wheels is described in EP-A2-0 300 383.

With reference to FIG. 1, the bracket 106 that the wheel is located on can be pivoted to achieve different cutting heights—yet the smaller gear and the gear cogs in the wheel stay in full contact for the drive system.

In order to assist the turning of the mower, the drive system has a “freewheeling” device 107. This is done by means of a simple “one-way” ratchet device (or one-way clutch) or even with a differential built into the transmission. When a ratchet device is used it is positioned at a small gear by the lawnmower wheel. This can often lead to some complications due to rust and dirt entering the system.

The drive axle 101 does not typically carry any of the weight of the mower. When utilizing the described height adjustment system it will also require that a very sturdy height adjustment bracket is used since the weight of the mower will try to bend the bracket. This does not only ad weight, but also complication to the system. The wheels are attached on a separate wheel axle 108 and a shield 109 is provided to prevent dirt from entering the inside of the wheel and gear mechanism.

A more simple system is to attach the wheels directly on a straight axle that runs from the left to the right side. The axle is attached directly to the height adjustment pivoting arms. This means that the height adjustment arms do not have to be designed for any of the torsion load generated by the wheel since these forces are carried by the wheel axle. Attaching the wheels directly to the axle is used on many successful designs in particular for an axle that does not drive the wheels such as a front axle on a rear wheel drive system. The systems in use, where the drive axle is directly attached to the wheel typically utilize a very complicated drive system enabling the belt drive to be fixed. One such design is described in the U.S. Pat. No. 3,529,482 of a friction disc transmission. In the known designs the drive axle is typically attached to a car type differential design. The use of a car type differential does not provide a reliable drive on small lawn mowers unless operated on flat ground—due to large weight shifts on the driven wheels when operating on a slope. The less weighted wheel will spin. This phenomenon can be prevented by using a “differential lock” design for small lawn mower transmissions.

There are transmission designs that utilize a system where the wheel is attached directly to the wheel axle of the transmission and where the entire transmission moves up and down relative to the mower deck when changing the height of the mower. One such solution is described in for example U.S. Pat. No. 4,554,780. The solutions used in those cases utilize a specialty engine with an internal power take off specifically for the transmission and separated from the crank shaft driving the rotary mower blade. The transmission is also in those cases powered by a propeller shaft as opposed to a simple belt and pulley design.

### SUMMARY OF THE INVENTION

An object of the present invention is to provide a transmission that overcomes some of the shortcomings of the transmissions of the prior art.

Another object is to provide a transmission which will lead to cost and weight savings of a lawn mower by reducing the final drive system to one location in the transmission as opposed to one in each wheel.

According to the invention a power transmission for a rotary type of walk-behind lawn mower is divided into at least a first and a second part. The first part is arranged to be mounted in a lawn mower housing and comprises a pulley arranged to be connected to an engine pulley of the lawn mower via a drive belt or similar. The second part is arranged to be connected to a wheel axle of a lawn mower. The first part is connected to the second part via a pivot axle such that the second part and the wheel axle are arranged to be pivotally mounted on said lawn mower housing. Thereby pivoting will adjust the height of said lawn mower housing in relation to a ground plane.

This brings about a transmission to be used in a lawn mower that in a simple yet effective way can be vertically adjusted. The wheel axle can thus be driven by the lawn mower engine and without use of a special engine design for driving the transmission and without using sturdy height adjustment brackets.

According to a preferred embodiment the transmission is provided with an internal freewheeling device. This hinders rust and dirt from entering the system since a freewheeling system arranged within the transmission housing is not exposed to dirt as a freewheeling system arranged in proximity to the wheels.

An object of the present invention is also to provide a lawn mower with the wheels attached directly to the wheel axle of the transmission and where the transmission is powered by a simple belt and pulley design.

A further object is to provide a lawn mower which height can be adjusted in relation to a ground plane without affecting the parallelity between a vertical transmission axle and an engine crank shaft.

According to the invention this is accomplished by a new rotary type of walk-behind lawn mower. The lawn mower comprises a housing, an engine mounted upon said housing, a mowing blade coupled to said engines crank shaft, an engine pulley coupled to said crank shaft, and a divided transmission. The divided transmission comprises at least two parts. The first part comprises a pulley connected to an engine pulley of a lawn mower via a drive belt or similar. The second part is connected to a wheel axle on one side of the second transmission part and is on another side connected to the first transmission part via a pivot axle. Thereby the second transmission part and the wheel axle are pivotally mounted on said housing via the pivot axle connecting the transmission parts. Pivoting around the pivot axle will adjust the height of said housing in relation to a ground plane.

This makes it possible to use a simple belt drive transmission as opposed to a propeller shaft transmission.

### BRIEF DESCRIPTION OF THE DRAWINGS

The invention will in the following be further explained, in a non-limiting manner, and with reference to the accompanying drawings, in which:

FIG. 1 shows an exploded view of a known height adjustment mechanism in a lawn mower;

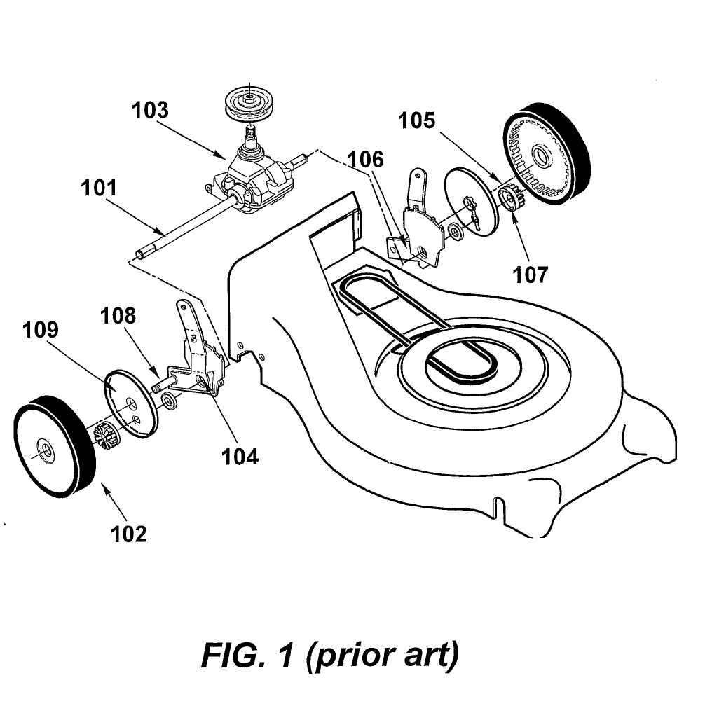

FIG. 2 shows an elevational side view of a lawn mower equipped with a transmission according to an embodiment of the present invention;

FIG. 3 shows a cross section of a transmission according to a preferred embodiment of the present invention;

FIG. 4 shows a detailed perspective view of a first and a second transmission part according to a preferred embodiment of the present invention, where the second transmission part is open,

FIG. 5 shows a perspective view of a lawn mower according to the invention where the mower deck is arranged in a low position,

FIG. 6 shows a perspective view of a lawn mower according to the invention where the mower deck is arranged in a raised position, and

FIG. 7 shows an elevational top view of a lawn mower according to the invention.

### DETAILED DESCRIPTION

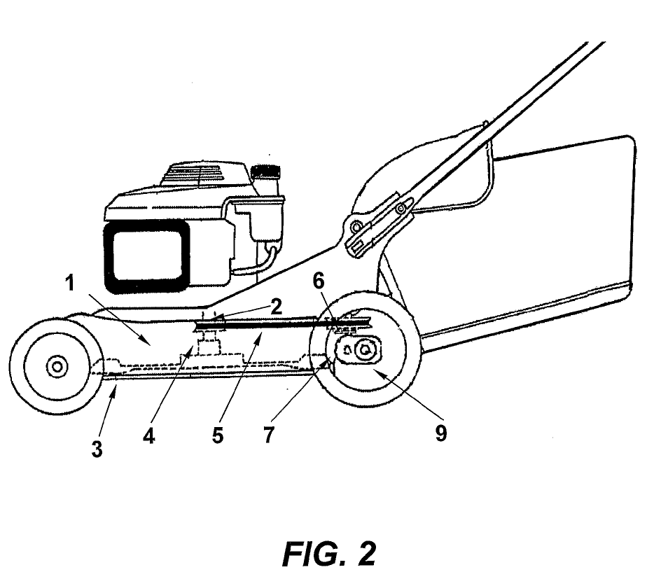

FIG. 2 shows a side view of a lawn mower equipped with a transmission according to an embodiment of the present invention. An engine, which can be any preferred known engine situated within a housing 1, is connected to a crank shaft 2, for rotation of the cutting blades 3. At the crank shaft 2, an engine pulley 4 is arranged for receiving a drive belt 5. The drive belt 5 connects the engine pulley 4 with a transmission pulley 6 arranged at a transmission/gear box 7. The transmission 7 is equipped with a hinge or an articulated joint or a pivot axle 11 which divides the transmission into two parts. The second part of the transmission is in turn connected to the wheel axle 9 running through the second transmission part.

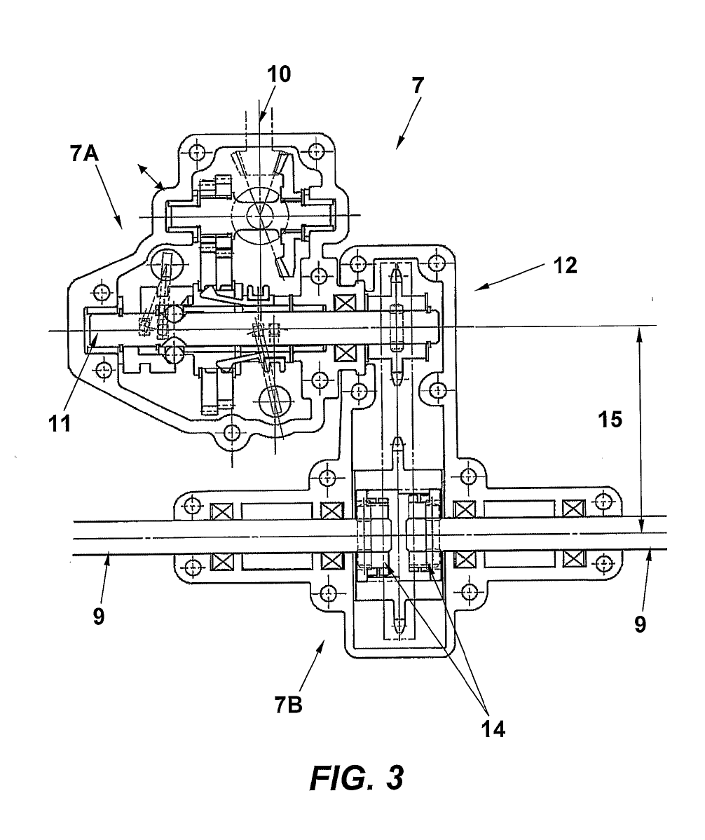

FIG. 3 shows a cross section of a transmission according to a preferred embodiment of the present invention. A transmission axle 10 transfers the momentum from the transmission pulley. A pivot axle 11 located in the first part 7A of the transmission 7 forwards the momentum and via a cog-chain system 12 a wheel axle 9 is arranged to rotate. According to this embodiment the wheel axle is divided into two parts each part being connected to a separate wheel. By dividing the axle into two parts a freewheeling system 14 can be provided in a second transmission part 7B. The freewheeling system 14 consists of a one-way ratchet device or a one-way clutch provided on each part of the wheel axle 9. By arranging an internal freewheeling device 14 in the transmission 7, problems encountered with conventional freewheeling systems, where the one-way devices are provided in close connection to the wheels, such as dirt, grass and rust can be diminished. The second transmission part 7B is pivotally attached to the first transmission part 7A at the pivot axle 11. The vertical position of the second transmission part 7B is kept at a constant vertical height in relation to the ground plane unless the wheels lose their contact with the ground. The wheel axle 9 is kept at a constant distance from the pivot axle 11, which corresponds to the pivot length 15. Due to the pivotal connection of the two transmission parts the vertical position of the first transmission part 7A can be changed which results in a raising or lowering of the mower deck relative to the ground without changing the vertical position of the second transmission part 7B. I.e. the transmission parts 7A, 7B can be vertically moved relative one another. A certain relative horizontal movement between the parts 7A, 7B will of course also take place. The first part 7A is to be attached to, or mounted in, the lawn mower housing 1. The second part 7B is to be attached to the wheel axle 9 preferably belonging to the rear wheels. When pivoting takes place, the first part 7A will move in relation to a ground plane and the lawn mower housing 1 will move in a corresponding fashion. The transmission axle 10 and the crank shaft 2 will thus keep its parallelity regardless of how much the position of the first transmission part 7A is changed, since the crank shaft 2 also is connected to the housing 1 in a similar manner as the first transmission part 7A.

The transmission 7 may also consist of more than two parts, although two parts are sufficient for achieving the objects of the present invention.

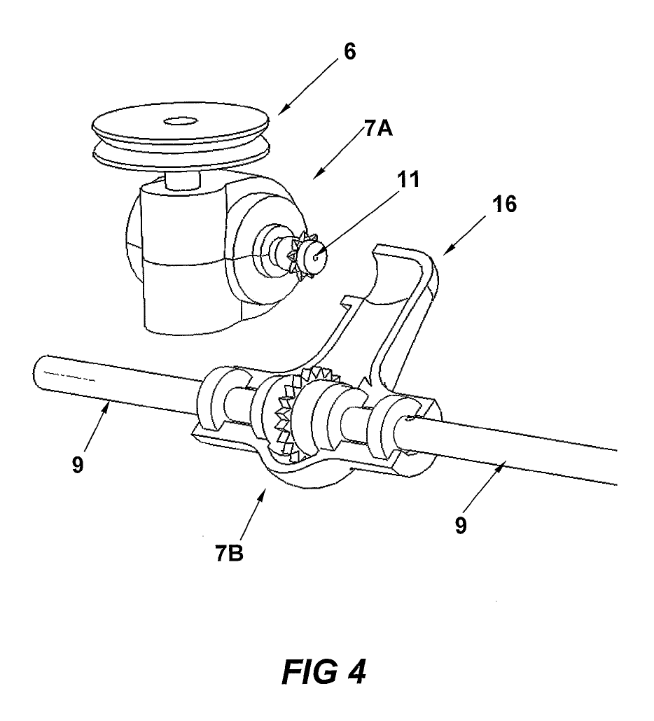

FIG. 4 shows a detailed perspective view of a first 7A and a second 7B transmission part, where the second 7B transmission part is open. In the figure the first 7A and the second 7B parts are separated from each other. The driving connection between the pivot axle 11 and the wheel axle 9 is not shown. The driving connection is preferably in the form of a regular chain connecting the cogs provided on the wheel axle 9 and the pivot axle 11 respectively. A rigid housing 16 makes sure that the distance between the two axles 11, 9 is kept at a constant pivot length 15.

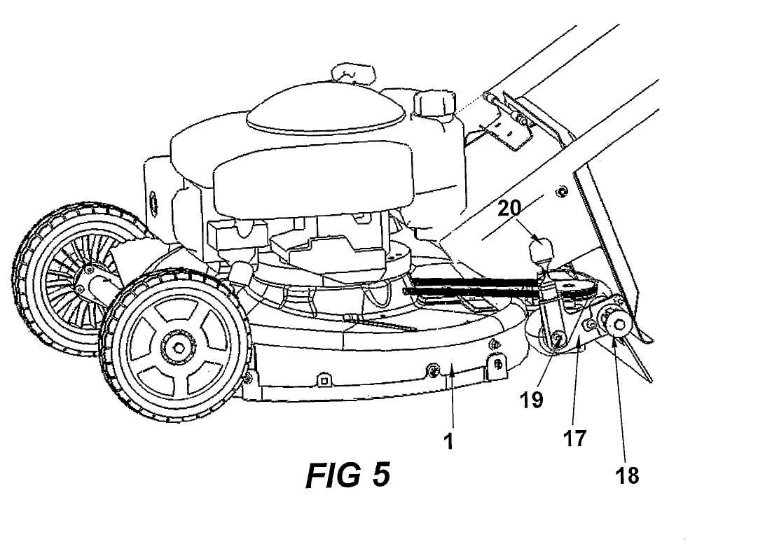

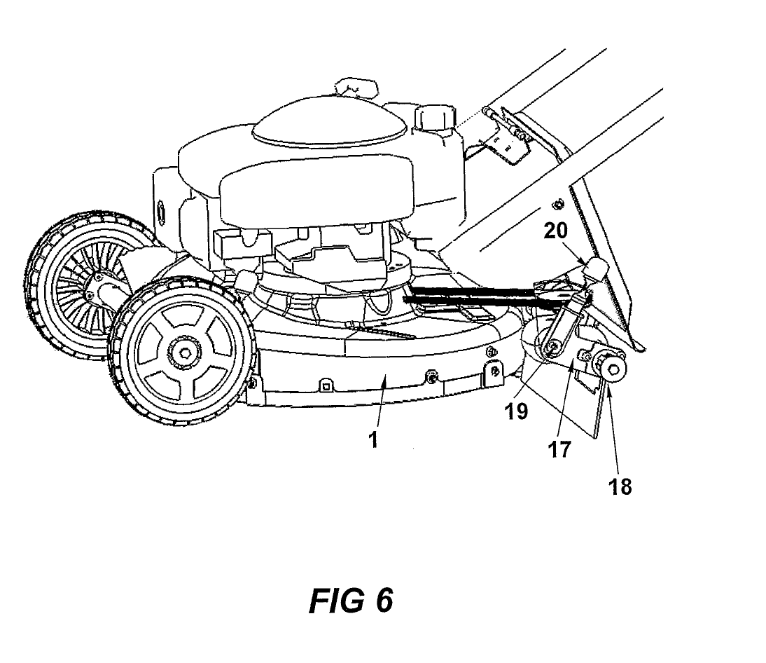

FIGS. 5 and 6 show perspective views of a lawn mower according to the invention where the mower deck is arranged in a low and a raised position respectively. For adjusting the lawn mowers cutting height a height adjustment mechanism 17 is interposed between at least one of the rear wheels and the housing/deck 1. The height adjuster mechanism 17 includes an adjusting bracket with connection points. One connection point 18 is connected to the wheel axle 9, a second connection point 19 is in alignment with the pivot axle 11 of the first transmission part 7A and connected to a mechanism preferably located in, or connected to, a handle 20 of the mower for influencing the height adjuster mechanism 17. The locations of the first 18 and the second 19 connection points on the bracket must be separated, and the second connection point 19 will constitute the rotational axis for the transmission since it is provided in line with the pivot axle 11. The connection point 19 and the pivot axle 11 can be indirectly connected to, or separated from, each other.

An operator can move the height adjustment mechanism 17 fore and aft, causing the wheel axle 9 and the pivot axle 11 to move relative one another and to raise or lower the mower body 1. Since the engine and the blade are mounted directly on the body 1, the blade moves up or down with the body 1 when the body 1 is raised or lowered by the height adjustment mechanism.

In this embodiment the transmission is provided in the rear of the lawn mower. However, the transmission can also be located in the front of the lawn mower in order to drive the front wheels instead of the back wheels. A connection can also be provided between the front and the back height adjustment brackets so that the entire lawn mower will be raised or lowered at the same time. Separate mechanisms for adjusting the heights for the front and the back wheels can also be provided.

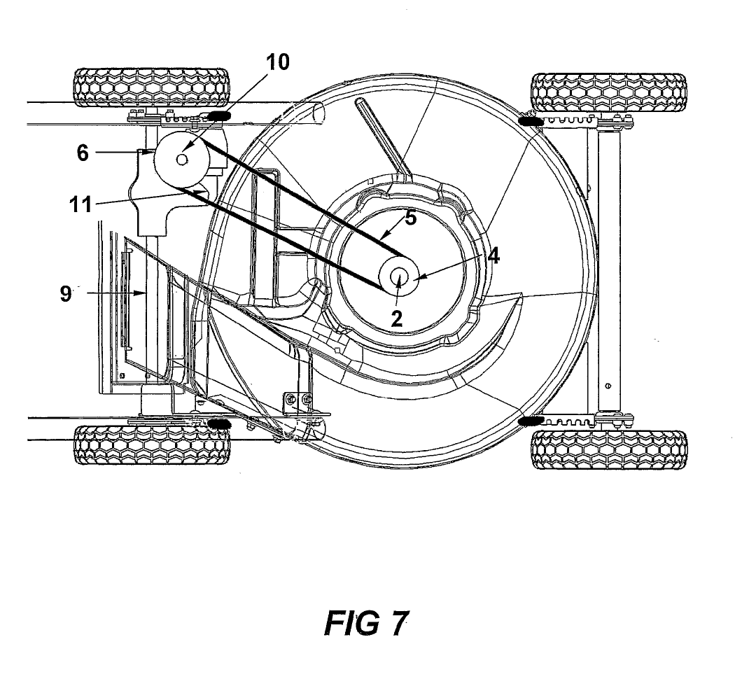

FIG. 7 shows an elevational top view of a lawn mower according to the invention. In order to facilitate the drive between an engine and a transmission by means of a belt and pulley design the invention assumes that a belt 5 is powered by a pulley 4 located on the shaft 2 that powers the cutting blades—typically the crankshaft on a gasoline powered engine. The belt 5 transmits the power from said engine pulley 4 to a second pulley 6 located on the transmission that powers the shaft 10 for the wheel axle 9. In order to leave the belt transmission at a fixed point yet allowing the wheel axle to move up and down relative to the mower deck, the transmission has a pivoting or articulating joint 11 that will correspond to the relative length and pivoting position of the height adjustment bracket that directly connects and supports the wheel axle to the mower deck. The articulating transmission can be combined and integrate any type of freewheeling device or even a differential design to enhance and enable easy turning of the lawn mower.

The wheel axle 9 is attached to the height adjustment devices 20 on the lawn mower. The articulated gearbox 7 has its pivoting point 11 in line with the pivoting point 19 of the height adjustment of the mower. The wheel axle 9 is in principal a rigid axle and the pivoting of the transmission 7 will therefore occur automatically at that time of a normal change of the cutting height of the mower.

The articulated transmission can be coupled to any type of reduction gearbox between the belt pulley and the final drive system. The belt drive can also consist of a simple variable ratio belt drive. The power from the engine is transmitted through a common V-belt. However, any other types of belt or chain could also be used.

In the known designs utilizing the system with a movable transmission the wheels are provided with a vulnerable freewheeling device.

By integrating final drive reduction typically located in the wheels and incorporating the freewheeling mechanism typically located at the wheels into the protected transmission/gearbox housing the inherent problem with rust and dirt is solved. This design will also result in substantial cost and weight savings by reducing the final drive system to one location in the transmission as opposed to one in each wheel. The incorporation of the freewheeling mechanism in the transmission can also be realized in a conventional transmission. The wheel axle must however be divided into two parts in order for the freewheeling to function.

It should be clear that the invention is not limited to the explicitly illustrated embodiments, but that it can be varied in a number of ways within the scope of the appended claims.

1.-9. (canceled)

10. A power transmission for a rotary type of walk-behind lawn mower comprising:
a first transmission part arranged to be mounted in a lawn mower housing and including a transmission pulley arranged to be connected to an engine pulley of the lawn mower via a drive belt; and
a second transmission part arranged to be connected to a wheel axle of the lawn mower;
wherein the first transmission part is connected to the second transmission part via a pivot axle such that the second transmission part and the wheel axle are pivotally mounted on the lawn mower housing, whereby pivoting adjusts a height of the lawn mower housing in relation to a ground plane.

11. The power transmission of claim 10, wherein the second transmission part includes an internal freewheeling device.

12. The power transmission of claim 10, wherein the second transmission part includes a differential.

13. A rotary type of walk-behind lawn mower, comprising:
a housing,
an engine mounted upon the housing,
a cutting blade coupled to a crank shaft of the engine,
an engine pulley coupled to the crank shaft,
a transmission including a transmission pulley, the transmission being arranged as a first transmission part coupled to the engine pulley via a drive belt, and as a second transmission part connected on one side to a wheel axle and on an other side to the first transmission part via a pivot axle such that the second transmission part and the wheel axle are pivotally mounted on the housing, whereby pivoting adjusts a height of the housing in relation to a ground plane.

14. The lawn mower of claim 13, wherein the wheel axle is divided into a first part and a second part, the first part of the wheel axle is connected to a left-hand-side wheel and the second transmission part, and the second part of the wheel axle is connected to a right-hand-side wheel and the second transmission part.

15. The lawn mower of claim 14, wherein the second transmission part includes a freewheeling device.

16. The lawn mower of claim 14, further comprising a height adjustment mechanism having at least first and second connection points, wherein the first connection point is connected to the wheel axle, and the second connection point is in alignment with the pivot axle of the first transmission part.

17. The lawn mower of claim 14, further comprising height adjustment mechanisms provided at both a front wheel axle and a rear wheel axle, wherein the height adjustment mechanisms are connected such that the height of the entire housing can be adjusted at the same time.

18. The lawn mower of claim 13, wherein the second transmission part includes a differential.

19. The lawn mower of claim 18, further comprising a height adjustment mechanism having at least first and second connection points, wherein the first connection point is connected to the wheel axle, and the second connection point is in alignment with the pivot axle of the first transmission part.

20. The lawn mower of claim 18, further comprising height adjustment mechanisms provided at both a front wheel axle and a rear wheel axle, wherein the height adjustment mechanisms are connected such that the height of the entire housing can be adjusted at the same time.

21. The lawn mower of claim 13, further comprising a height adjustment mechanism having at least first and second connection points, wherein the first connection point is connected to the wheel axle, and the second connection point is in alignment with the pivot axle of the first transmission part.

22. The lawn mower of claim 13, further comprising height adjustment mechanisms provided at both a front wheel axle and a rear wheel axle, wherein the height adjustment mechanisms are connected such that the height of the entire housing can be adjusted at the same time.
